(19) United States
(12) Patent Application Publication
(10) Pub. No.: US 2024/0202816 A1
(43) Pub. Date: Jun. 20, 2024

(54) SYSTEMS AND METHODS FOR DYNAMICALLY GENERATING PRE-APPROVAL DATA

(71) Applicant: Capital One Services, LLC, McLean, VA (US)

(72) Inventor: Aaron Attar, Dallas, TX (US)

(21) Appl. No.: 18/066,500

(22) Filed: Dec. 15, 2022

(51) Int. Cl. G06Q 40/03

(52) U.S. Cl. CPC G06Q 40/03

(57) ABSTRACT

Disclosed embodiments may include a method for dynamically generating preapproval data. The method may include receiving first identity information, generating a pre-approval rate and a confidence score based on the first identity information, generating a graphical user interface (GUI) comprising the pre-approval rate, the confidence score, and a request for additional information, transmitting the GUI to a user device for display, receiving additional information, generating an updated pre-approval rate and an updated confidence score based on the first identity information and the additional information, generating an updated GUI comprising the updated pre-approval rate and the updated confidence score, and transmitting the updated GUI to the user device for display in place of the GUI

The disclosed technology relates to systems and methods for dynamically generating preapproval data. Specifically, this disclosed technology relates to generating and providing for display in a graphical user interface (GUI) a pre-approval rate and confidence score for a potential buyer that dynamically changes as more information is inputted into the system.

### BACKGROUND

Before a customer purchases a vehicle at a dealer, they are given options to apply for a loan for the purchase of the vehicle via one or more banks associated with the dealer. These options are often based on incomplete identity information about the customer or the vehicle the customer intends to purchase often preventing or delaying pre-approval of a loan.

Accordingly, there is a need for improved systems and methods for dynamically generating preapproval data. Embodiments of the present disclosure are directed to this and other considerations.

### SUMMARY

Disclosed embodiments may include a system for dynamically generating preapproval data. The system may include one or more processors, and memory in communication with the one or more processors and storing instructions that, when executed by the one or more processors, are configured to cause the system to provide dynamically generating preapproval data. The system may receive first identity information (e.g., first and last name), receive vehicle information comprising a price of a vehicle, generate a pre-approval rate (e.g., projected rate) and a confidence score based on the first identity information and vehicle information, generate a graphical user interface (GUI) comprising the pre-approval rate, the confidence score, and a request for additional information (e.g., social security number), transmit the GUI to a user device for display, receive additional information, generate an updated pre-approval rate and an updated confidence score based on the first identity information, the vehicle information, and the additional information, generate an updated GUI comprising the updated pre-approval rate and the updated confidence score, and transmit the updated GUI to the user device to for display in place of the GUI.

Disclosed embodiments may include a system for dynamically generating preapproval data. The system may include one or more processors, and memory in communication with the one or more processors and storing instructions that, when executed by the one or more processors, are configured to cause the system to provide dynamically generating preapproval data. The system may receive first identity information, generate a pre-approval rate and a confidence score based on the first identity information, generate a graphical user interface (GUI) comprising the pre-approval rate, the confidence score, and a request for additional information, transmit the GUI to a user device for display, receive additional information, generate an updated pre-approval rate and an updated confidence score based on the first identity information and the additional information, generate an updated GUI comprising the updated pre-approval rate and the updated confidence score, and transmit the updated GUI to the user device for display in place of the GUI.

Disclosed embodiments may include a method for dynamically generating preapproval data. The method may include receiving first identity information, generating a pre-approval rate and a confidence score based on the first identity information, generating a graphical user interface (GUI) comprising the pre-approval rate, the confidence score, and a request for additional information, transmitting the GUI to a user device for display, receiving additional information, generating an updated pre-approval rate and an updated confidence score based on the first identity information and the additional information, generating an updated GUI comprising the updated pre-approval rate and the updated confidence score, and transmitting the updated GUI to the user device for display in place of the GUI.

Disclosed embodiments may include a system for dynamically generating preapproval data. The system may include one or more processors; memory in communication with the one or more processors and storing instructions that are configured to cause the dynamic pre-approval system to perform the following steps. The system may cause a user device to display a graphical user interface (GUI) that includes a plurality of editable fields, a first subset of the plurality of editable fields associated with identity information, and a second subset of the plurality of editable fields associated with vehicle information. The system may monitor the plurality of editable fields for edits. The system may dynamically determine a pre-approval based on the monitoring of the plurality of editable fields by, for each edit of a plurality of edits to the plurality of fields (i) using a current state of the plurality of fields to generate a pre-approval rate and a confidence score and (ii) causing the user device to update the GUI with the pre-approval rate and the confidence score based on the current state of the plurality of fields, such that the pre-approval rate and the confidence score are dynamically updated with each edit of the plurality of edits.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for dynamically generating preapproval data in accordance with certain embodiments of the disclosed technology.

FIG. 2 is a flow diagram illustrating an exemplary method for dynamically generating preapproval data in accordance with certain embodiments of the disclosed technology.

FIG. 3 is block diagram of an example dynamic pre-approval system used to provide dynamically generating preapproval data, according to an example implementation of the disclosed technology.

FIG. 4 is block diagram of an example system that may be used to provide dynamically generating preapproval data, according to an example implementation of the disclosed technology.

FIG. 5 is a flow diagram illustrating an exemplary method for dynamically generating preapproval data, in accordance with certain embodiments of the disclosed technology.

### DETAILED DESCRIPTION

Examples of the present disclosure related to systems and methods for dynamically generating preapproval data. More particularly, the disclosed technology relates to generating and providing for display in a graphical user interface (GUI) a pre-approval rate and confidence score for a potential buyer that dynamically changes as more information is inputted into the system. The systems and methods described herein utilize, in some instances, machine learning models, which are necessarily rooted in computers and technology. Machine learning models are a unique computer technology that involves training models to complete tasks and make decisions. The present disclosure details generating and providing for display, via a GUI, a pre-approval rate and confidence score for a potential buyer that dynamically changes as more information is inputted into the system as well as prompting a user to enter additional information to allow the system to generate a more accurate pre-approval rate and confidence score. This, in some examples, may involve using customer identification information (e.g., social security number, legal name, birthdate) and information about the item to be purchased (e.g., a vehicle make, model, year, and condition) as input data and a machine learning model, applied and trained to analyze the input data and generate a pre-approval rate and confidence score that a full approval will results in the pre-approval rate, and outputs a result of pre-approval rate and confidence score. Using a machine learning model in this way may allow the system to provide a customer and dealer with a near instant and dynamic pre-approval information to allow a customer to more accurately select an appropriate lender.

The systems and methods described herein utilize, in some instances, GUI, which are necessarily rooted in computers and technology. Graphical user interfaces are a computer technology that allows for user interaction with computers through touch, pointing devices, or other means. The present disclosure details generating and providing for display in a graphical user interface (GUI) a pre-approval rate and confidence score for a potential buyer that dynamically changes as more information is inputted into the system. This, in some examples, may involve using customer identification information (e.g., social security number, legal name, birthdate) and information about the item to be purchased (e.g., a vehicle make, model, year, and condition) as input data to dynamically change the graphical user interface as additional information is entered so that the GUI displays updated results (e.g., pre-approved rates and confidence scores), which involves using specialized computer components that is configured to perform a specific task. Using a graphical user interface in this way may allow the system to provide a dealer or other user with dynamic information informing both a user and the dealer of options for funding the purchase of an item (e.g., a vehicle).

These are clear advantages and improvements over prior technologies that rely on slow results that must be reentered to be updated or resulting rates that do not closely correspond to a full approved loan rates. The present disclosure solves this problem by receiving input data as is it typed and updating its results dynamically. Furthermore, examples of the present disclosure may also improve the speed with which computers can generate and update pre-approval rates. Overall, the systems and methods disclosed have significant practical applications in the computing technology field because of the noteworthy improvements of the machine learning model using dynamic data inputs to generate dynamic reports, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

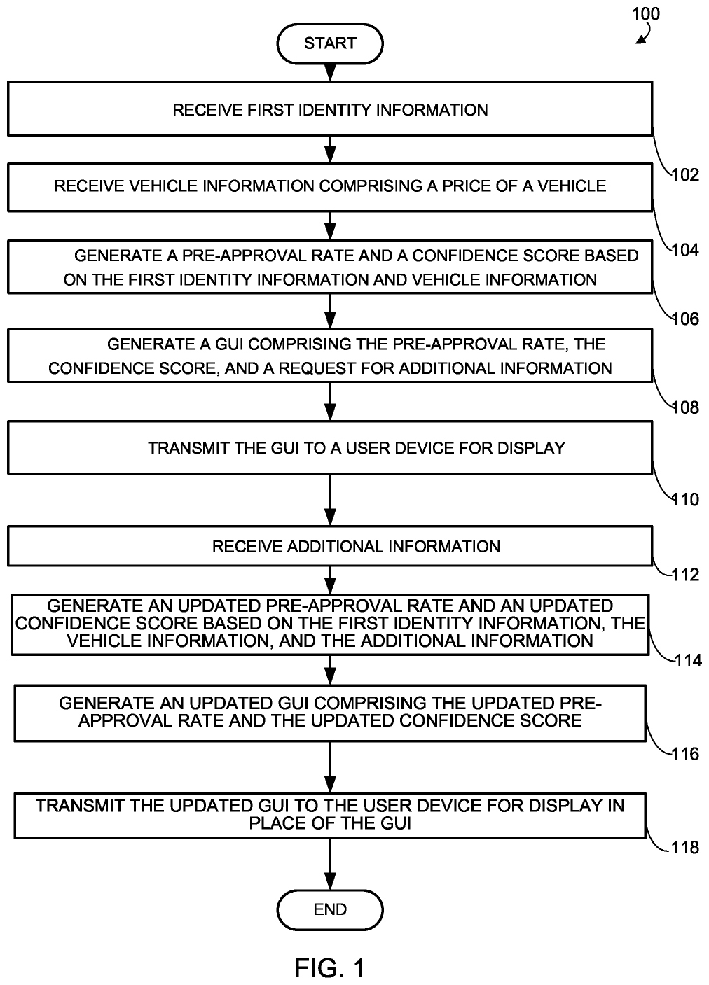

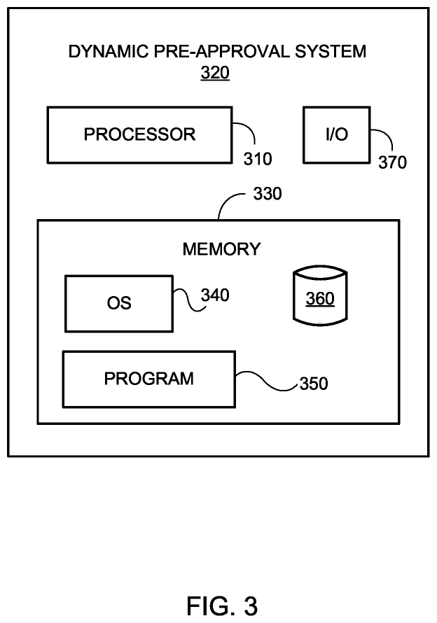

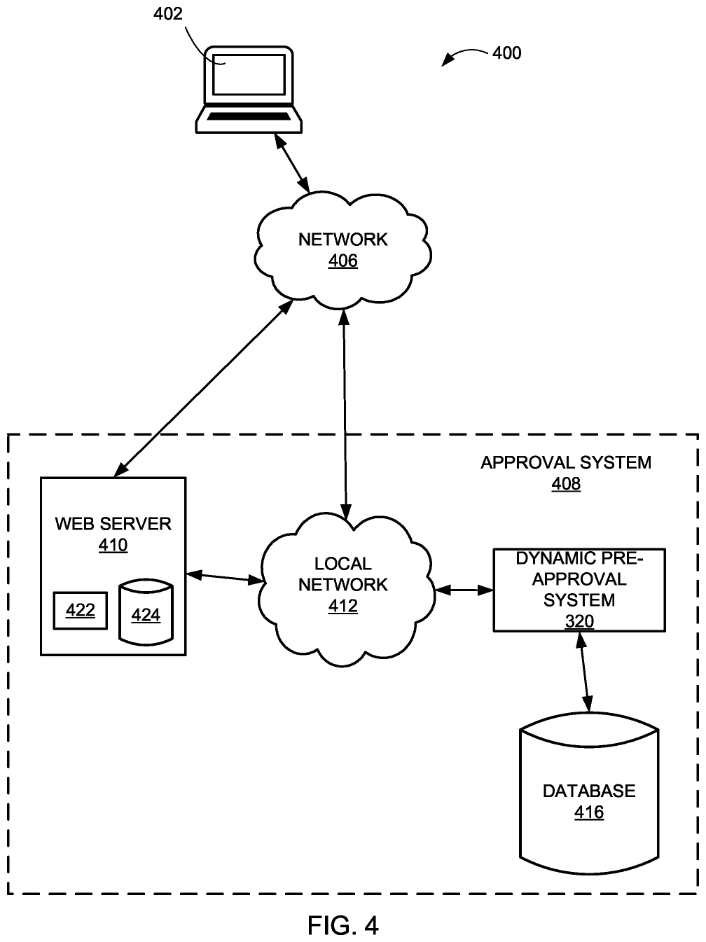

FIG. 1 is a flow diagram illustrating an exemplary method 100 for dynamically generating preapproval data, in accordance with certain embodiments of the disclosed technology. The steps of method 100 may be performed by one or more components of the system 400 (e.g., dynamic pre-approval system 320 or web server 410 of approval system 408 or user device 402), as described in more detail with respect to FIGS. 3 and 4.

In block 102, the dynamic pre-approval system 320 may receive first identity information. The identity information may include first name, last name, an identity number (e.g., social security number), birthdate, home address, or combinations thereof. For example, a user from a vehicle dealer may enter the first and last name of the potential buyer into a user device 402 associated with a dealer. By doing so the dynamic pre-approval system 320 may receive the same information via network 406 and/or network 412.

In block 104, the dynamic pre-approval system 320 may receive vehicle/item information. Vehicle information may include a vehicle price, vehicle identification number (VIN), vehicle make, vehicle model, vehicle year, or combinations thereof. For example, the same user from the vehicle dealer may enter the price of the vehicle/item the potential buyer intends to purchase. By doing so the dynamic pre-approval system 320 may receive the same information via network 406 and/or network 412.

In block 106, the dynamic pre-approval system 320 may generate a pre-approval rate and a confidence score based on the first identity information and vehicle information. For example, the dynamic pre-approval system 320 may generate a pre-approval rate of as low as 6.5% for a 36-month loan with a confidence score of 65% that the potential buyer associated with the first identity information could secure such a loan from a first lender. The dynamic pre-approval system 320 may utilize a machine learning model, such as one described below, to generate the confidence score based on training data and the first identity information and the vehicle information.

In block 108, the dynamic pre-approval system 320 may generate a graphical user interface (GUI) includes the pre-approval rate, the confidence score, and a request for additional information. The dynamic pre-approval system 320 may also generate a request for additional information (e.g., a social security number, vehicle condition information, vehicle price) that if supplied would increase the confidence score to, for example, 85% for the same loan. The request for additional information may include an estimate for how much the confidence score will increase if the additional information is accurately supplied.

In block 110, the dynamic pre-approval system 320 may transmit the GUI to user device 402 for display.

In block 112, the dynamic pre-approval system 320 may receive additional information from the user device 402 or from another computing device. The additional information may be first identity information, vehicle/item information, or other information. For example, the additional information may include additional first identity information (e.g., an identity number such as a social security number).

In block 114, the dynamic pre-approval system 320 may generate an updated pre-approval rate and an updated confidence score based on the first identity information, the vehicle information, and the additional information. For example, since the dynamic pre-approval system 320 may have received first identity information (e.g., first and last name of the potential buyer), vehicle/item information (e.g., price of the vehicle/item), and additional first identity information (e.g., an identity number such as a social security number), the dynamic pre-approval system 320 may be able to update the pre-approval rate to 6.2% and the confidence score to 90%.

In block 116, the dynamic pre-approval system 320 may generate an updated GUI comprising the updated pre-approval rate and the updated confidence score. For example, the updated GUI may replace the previous pre-approval rate and the previous confidences score with the updated pre-approval rate and the updated confidence score. The update GUI may also include an indication that the pre-approval rate and/or confidence score improved or got worse (e.g. the confidence score decrease and/or the pre-approval rate increased). Otherwise, the updated GUI may be generally the same as the GUI.

In block 118, the dynamic pre-approval system 320 may transmit the updated GUI to the user device for display in place of the GUI.

The dynamic pre-approval system 320 may also determine whether the first identity information (e.g., identity number such as a social security number) or additional information corresponds to retrieved or stored an identity number (e.g., social security number). Responsive to the dynamic pre-approval system 320 determining that the first identity information does correspond to the identity number, the dynamic pre-approval system 320 may modify the updated GUI. Responsive to the dynamic pre-approval system 320 determining that the first identity information corresponds to the identity number, the dynamic pre-approval system 320 may modify the updated GUI to comprise an indication that the first identity information corresponds to the additional information.

The dynamic pre-approval system 320 may determine, using a machine learning model and a vehicle information database (part of database 360, 416, or a third-party database), whether the vehicle information is accurate; and responsive to determining that the vehicle information is not accurate, modify the updated GUI to comprise an indication (e.g., an “X”, a red filled shape such as a circle, and/or text that states “Not Verified”) that the vehicle information is not accurate. Responsive to the dynamic pre-approval system 320 determining that the vehicle information is accurate, modify the updated GUI to comprise an indication (e.g., a check mark, a green filled shape such as a circle, and/or text that states “Not Verified”) that the vehicle information is accurate.

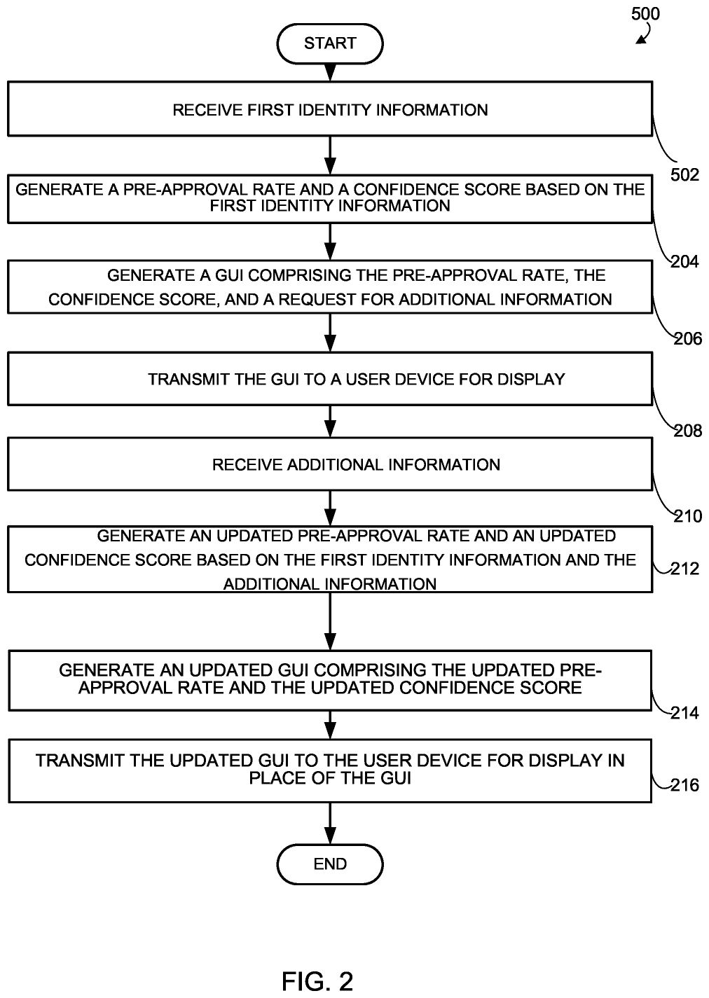

FIG. 2 is a flow diagram illustrating an exemplary method 200 for dynamically generating preapproval data, in accordance with certain embodiments of the disclosed technology. The steps of method 200 may be performed by one or more components of the system 400 (e.g., dynamic pre-approval system 320 or web server 410 of approval system 408 or user device 402), as described in more detail with respect to FIGS. 3 and 4.

Method 200 of FIG. 2 is similar to method 100 of FIG. 1, except that method 200 may not include block 104 of method 100. The descriptions of blocks 202, 204, 206, 208, 210, 212, and 216 in method 200 are similar to the respective descriptions of blocks 102, 106, 108, 110, 112, 116, and 118 of method 100 and are not repeated herein for brevity. However, block 204 and 206 are different from block 106 and 108 and are described below.

In block 204, the dynamic pre-approval system 320 may generate a pre-approval rate and a confidence score based on the first identity information as described above.

In block 206, the dynamic pre-approval system 320 may generate a graphical user interface (GUI) comprising the pre-approval rate, the confidence score, and a request for additional information. The additional information may be vehicle/item information or additional first identity information.

FIG. 3 is a block diagram of an example dynamic pre-approval system 320 used to generate a pre-approval rate and a confidence score according to an example implementation of the disclosed technology. According to some embodiments, the user device 402 and web server 410, as depicted in FIG. 4 and described below, may have a similar structure and components that are similar to those described with respect to dynamic pre-approval system 320 shown in FIG. 3. As shown, the dynamic pre-approval system 320 may include a processor 310, an input/output (I/O) device 370, a memory 330 containing an operating system (OS) 340 and a program 350. In certain example implementations, the dynamic pre-approval system 320 may be a single server or may be configured as a distributed computer system including multiple servers or computers that interoperate to perform one or more of the processes and functionalities associated with the disclosed embodiments. In some embodiments dynamic pre-approval system 320 may be one or more servers from a serverless or scaling server system. In some embodiments, the dynamic pre-approval system 320 may further include a peripheral interface, a transceiver, a mobile network interface in communication with the processor 310, a bus configured to facilitate communication between the various components of the dynamic pre-approval system 320, and a power source configured to power one or more components of the dynamic pre-approval system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the dynamic pre-approval system 320 may include one or more storage devices configured to store information used by the processor 310 (or other components) to perform certain functions related to the disclosed embodiments. In one example, the dynamic pre-approval system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The dynamic pre-approval system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the dynamic pre-approval system 320 may include the memory 330 that may include one or more programs 350 to perform one or more functions of the disclosed embodiments. For example, in some embodiments, the dynamic pre-approval system 320 may additionally manage dialogue and/or other interactions with the customer via a program 350.

The processor 310 may execute one or more programs 350 located remotely from the dynamic pre-approval system 320. For example, the dynamic pre-approval system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a dynamic pre-approval system database 360 for storing related data to enable the dynamic pre-approval system 320 to perform one or more of the processes and functionalities associated with the disclosed embodiments.

The dynamic pre-approval system database 360 may include stored data relating to status data (e.g., average session duration data, location data, idle time between sessions, and/or average idle time between sessions) and historical status data. According to some embodiments, the functions provided by the dynamic pre-approval system database 360 may also be provided by a database that is external to the dynamic pre-approval system 320, such as the database 416 as shown in FIG. 4.

The dynamic pre-approval system 320 may also be communicatively connected to one or more memory devices (e.g., databases) locally or through a network. The remote memory devices may be configured to store information and may be accessed and/or managed by the dynamic pre-approval system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The dynamic pre-approval system 320 may also include one or more I/O devices 370 that may comprise one or more interfaces for receiving signals or input from devices and providing signals or output to one or more devices that allow data to be received and/or transmitted by the dynamic pre-approval system 320. For example, the dynamic pre-approval system 320 may include interface components, which may provide interfaces to one or more input devices, such as one or more keyboards, mouse devices, touch screens, track pads, trackballs, scroll wheels, digital cameras, microphones, sensors, and the like, that enable the dynamic pre-approval system 320 to receive data from a user (such as, for example, via the user device 402).

In examples of the disclosed technology, the dynamic pre-approval system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The dynamic pre-approval system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The dynamic pre-approval system 320 may be configured to adjust model parameters during training. Model parameters may include weights, coefficients, offsets, or the like. Training may be supervised or unsupervised.

The dynamic pre-approval system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The dynamic pre-approval system 320 may be configured to optimize statistical models using known optimization techniques.

Furthermore, the dynamic pre-approval system 320 may include programs configured to retrieve, store, and/or analyze properties of data models and datasets. For example, dynamic pre-approval system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The dynamic pre-approval system 320 may include algorithms to determine a data type, key-value pairs, row-column data structure, statistical distributions of information such as keys or values, or other property of a data schema may be configured to return a statistical profile of a dataset (e.g., using a data-profiling model). The dynamic pre-approval system 320 may be configured to implement univariate and multivariate statistical methods. The dynamic pre-approval system 320 may include a regression model, a Bayesian model, a statistical model, a linear discriminant analysis model, or other classification model configured to determine one or more descriptive metrics of a dataset. For example, dynamic pre-approval system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The dynamic pre-approval system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, dynamic pre-approval system 320 may be configured to generate a similarity metric representing a measure of similarity between data in a dataset. A similarity metric may be based on a correlation, covariance matrix, a variance, a frequency of overlapping values, or other measure of statistical similarity.

The dynamic pre-approval system 320 may be configured to generate a similarity metric based on data model output, including data model output representing a property of the data model. For example, dynamic pre-approval system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The dynamic pre-approval system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The dynamic pre-approval system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, dynamic pre-approval system 320 is configured to generate and/or train a classification model to classify a dataset, consistent with disclosed embodiments.

The dynamic pre-approval system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the dynamic pre-approval system may analyze information applying machine-learning methods.

While the dynamic pre-approval system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the dynamic pre-approval system 320 may include a greater or lesser number of components than those illustrated.

FIG. 4 is a block diagram of an example system that may be used to view and interact with approval system 408, according to an example implementation of the disclosed technology. The components and arrangements shown in FIG. 4 are not intended to limit the disclosed embodiments as the components used to implement the disclosed processes and features may vary. As shown, approval system 408 may interact with a user device 402 via a network 406. In certain example implementations, the approval system 408 may include a local network 412, a dynamic pre-approval system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the approval system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the approval system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The dynamic pre-approval system 320 may include programs (scripts, functions, algorithms) to configure data for visualizations and provide visualizations of datasets and data models on the user device 402. This may include programs to generate graphs and display graphs. The dynamic pre-approval system 320 may include programs to generate histograms, scatter plots, time series, or the like on the user device 402. The dynamic pre-approval system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The approval system 408 may be associated with and optionally controlled by one or more entities such as a business, corporation, individual, partnership, or any other entity that provides one or more of goods, services, and consultations to individuals such as customers. In some embodiments, the approval system 408 may be controlled by a third party on behalf of another business, corporation, individual, partnership. The approval system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the dynamic pre-approval system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the approval system 408 to interact with one another and to connect to the network 406 for interacting with components in the system 400 environment. In some embodiments, the local network 412 may include an interface for communicating with or linking to the network 406. In other embodiments, certain components of the approval system 408 may communicate via the network 406, without a separate local network 406.

The approval system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access approval system 408 using the cloud computing environment. User device 402 may be able to access approval system 408 using specialized software. The cloud computing environment may eliminate the need to install specialized software on user device 402.

In accordance with certain example implementations of the disclosed technology, the approval system 408 may include one or more computer systems configured to compile data from a plurality of sources the dynamic pre-approval system 320, web server 410, and/or the database 416. The dynamic pre-approval system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

Although the preceding description describes various functions of a web server 410, a dynamic pre-approval system 320, and a database 416, in some embodiments, some or all of these functions may be carried out by a single computing device.

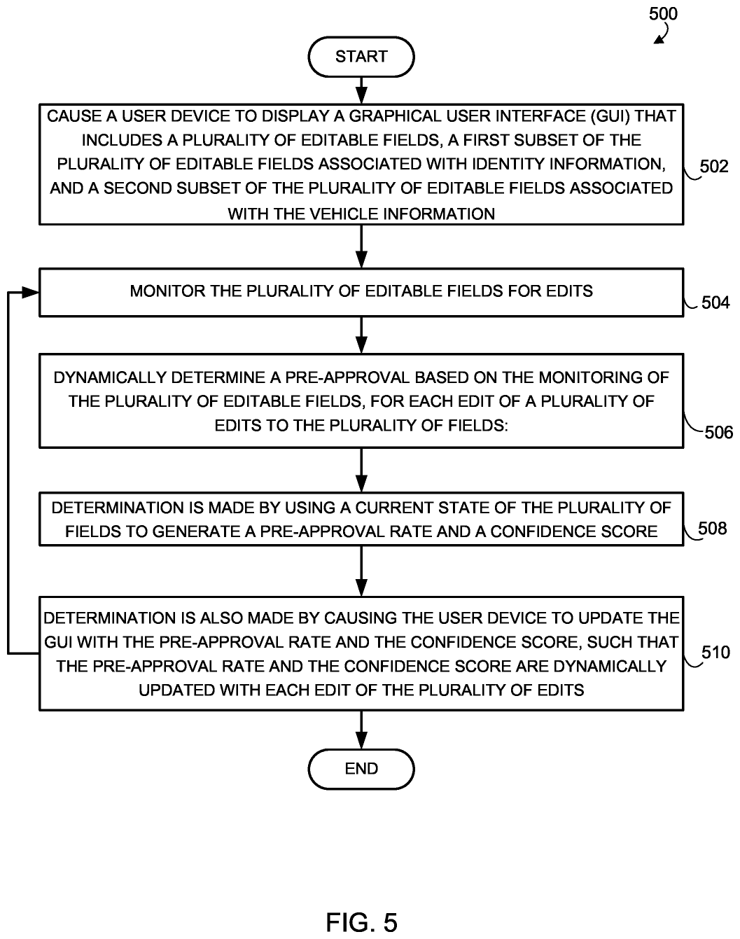

FIG. 5 is a flow diagram illustrating an exemplary method 500 for dynamically generating preapproval data, in accordance with certain embodiments of the disclosed technology. The steps of method 500 may be performed by one or more components of the system 400 (e.g., dynamic pre-approval system 320 or web server 410 of approval system 408 or user device 402), as described in more detail with respect to FIGS. 3 and 4.

In block 502, the dynamic pre-approval system 320 may cause a user device 402 to display a graphical user interface (GUI) that includes plurality of editable fields, a first subset of the plurality of editable fields associated with identity information and a second subset of the plurality of editable fields associated with the vehicle information. The identity information may include first name, last name, an identity number (e.g., social security number), birthdate, home address, or combinations thereof. For example, a user from a vehicle dealer may enter the first and last name of the potential buyer into a user device 402 associated with a dealer. The identity information entered into the one or more editable fields by a user at user device may be incomplete, partial, wrong (e.g., such as misspelling a person's name) information. By entering the information into the user device 402, the dynamic pre-approval system 320 may receive the same information via network 406 and/or network 412. Vehicle information may include a vehicle price, vehicle identification number (VIN), vehicle make, vehicle model, vehicle year, or combinations thereof. For example, the same user from the vehicle dealer may enter the price of the vehicle/item the potential buyer intends to purchase into user device 402. The vehicle information received or enter by a user may be incomplete, partial, or wrong. By entering the information into the user device 402, the dynamic pre-approval system 320 may receive the same information via network 406 and/or network 412.

In block 504, the dynamic pre-approval system 320 may monitor the plurality of editable fields for edits. For example, the dynamic pre-approval system 320 may detect when a field has been edited (e.g., added or removed characters (e.g., text)) by a user of user device 402. In some instances, every input to the GUI is immediately transmitted to the dynamic pre-approval system 320 for processing in blocks 506, 508, and 510.

In block 506, the dynamic pre-approval system 320 may dynamically determine a pre-approval based on the monitoring of the plurality of editable fields for each edit of the plurality. In some embodiments, the pre-approval determined by a threshold level of a determined confidence score and pre-approval rate.

In block 508, the dynamic pre-approval system 320 may make the dynamic determination of block 506 by using a current state of the plurality of fields to generate a pre-approval rate and a confidence score.

In block 510, the dynamic pre-approval system 320 may make the dynamic determination of block 506 by also causing the user device to update the GUI with the pre-approval rate and the confidence score, such that the pre-approval rate and the confidence score are dynamically updated with each edit of the plurality of edits. For example, the dynamic pre-approval system 320 may receive a 9-digit social security number from user device 402. Until all nine digits are entered, the dynamic pre-approval system 320 may cause the GUI may simply state “undetermined” or similar status indicator since the dynamic pre-approval system 320 doesn't have enough information to provide pre-approval to an individual. However, once the ninth digit is entered, the dynamic pre-approval system 320 may cause the GUI to generate a confidence score and a pre-approval rate for the individual. Similarly, i the dynamic pre-approval system 320 receives enough information to identify a vehicle (e.g., make, model, year, and/or mileage), the dynamic pre-approval system 320 will update the pre-approval rate and the confidence score GUI as it receives additional information. The confidence score is how confident the system is that the individual applying for financing will be able to receive the pre-approval rate.

The dynamic pre-approval system 320 may also determine whether the first identity information (e.g., identity number such as a social security number) or additional information corresponds to retrieved or stored an identity number (e.g., social security number). Responsive to the dynamic pre-approval system 320 determining that the first identity information does correspond to the identity number, the dynamic pre-approval system 320 may update the GUI. Responsive to the dynamic pre-approval system 320 determining that the first identity information corresponds to the identity number, the dynamic pre-approval system 320 may update the GUI to comprise an indication that the first identity information corresponds to the additional information.

The dynamic pre-approval system 320 may determine, using a machine learning model (trained to generate confidence scores from incomplete and complete identify information, vehicle information, or both) and a vehicle information database (part of database 360, 416, or a third-party database), whether the vehicle information is accurate; and responsive to determining that the vehicle information is not accurate, modify the updated GUI to comprise an indication (e.g., an “X”, a red filled shape such as a circle, and/or text that states “Not Verified”) that the vehicle information is not accurate. Responsive to the dynamic pre-approval system 320 determining that the vehicle information is accurate, modify the updated GUI to comprise an indication (e.g., a check mark, a green filled shape such as a circle, and/or text that states “Not Verified”) that the vehicle information is accurate.

Blocks 504, 506, 508, and 510 may be repeated until no new information is entered or edits made via user device 402 or that user device has exited the GUI/financing session.

### Example Use Case

The following example use case describes an example of a typical user flow pattern. This section is intended solely for explanatory purposes and not in limitation.

In one example, John decides that we want to purchase a new F-150 truck from the local Ford dealership after doing research and test driving the car. Celeste, the dealership salesperson, offers to provide John with lending options via banks associated with the dealership. Celeste enters John's full name into user device 402 and the price (e.g., $40,000) of the vehicle that they agree to as well as the down payment amount John intends to provide. Thus, dynamic pre-approval system 320 receives first identity information (e.g., John's full name) from user device 402 as well as the price of the vehicle via the network as soon as it is typed into the system. Celeste may type other vehicle information as well. dynamic pre-approval system 320 generates a pre-approval rate (e.g., 5.6%) and a confidence score (e.g., 70% with 100% being the highest confidence that the customer will be approved at the date) based on the first identity information and vehicle information. dynamic pre-approval system 320 generates a graphical user interface (GUI) comprising the pre-approval rate, the confidence score, and a request for additional information such as John's social security number. dynamic pre-approval system 320 transmits the GUI to a user device for display.

Upon seeing the request for additional information or in this case a social security number, Celeste may input into user device 402 a social security number that John shares i.e., the requested additional information. Upon receiving the additional information, dynamic pre-approval system 320 generates an updated pre-approval rate (e.g., lowers the projected rate to 5.2%) and an updated confidence score (e.g., increases the confidence score to 90%) based on the first identity information (e.g., first and last name), the vehicle information (e.g., at least the vehicle price, if not make, model, and year), and the additional information (e.g., social security information) and generate an updated GUI comprising the updated pre-approval rate and the updated confidence score and transmit the updated GUI to the user device to for display in place of the GUI.

In some examples, disclosed systems or methods may involve one or more of the following clauses:

Clause 1: A dynamic pre-approval system comprising: one or more processors; memory in communication with the one or more processors and storing instructions that are configured to cause the dynamic pre-approval system to: receive first identity information; receive vehicle information comprising a price of a vehicle; generate a pre-approval rate and a confidence score based on the first identity information and vehicle information; generate a graphical user interface (GUI) comprising the pre-approval rate, the confidence score, and a request for additional information; transmit the GUI to a user device for display; receive additional information; generate an updated pre-approval rate and an updated confidence score based on the first identity information, the vehicle information, and the additional information; generate an updated GUI comprising the updated pre-approval rate and the updated confidence score; and transmit the updated GUI to the user device to for display in place of the GUI.

Clause 2: The dynamic pre-approval system of clause 1, wherein the first identity information comprises first name, last name, an identity number, birthdate, home address, or combinations thereof.

Clause 3: The dynamic pre-approval system of clause 1 wherein: the first identity information comprises first name and last name; and the additional information comprises an identity number.

Clause 4: The dynamic pre-approval system of clause 3, wherein the memory stores further instructions that are configured to cause the system to: determine whether the first identity information corresponds to a retrieved or stored identity number; and responsive to determining that the first identity information does not correspond to the retrieved or stored identity number, modify the updated GUI to comprise an indication that the first identity information does not correspond to the additional information.

Clause 5: The dynamic pre-approval system of clause 4, wherein the memory stores further instructions that are configured to cause the system to: responsive to determining that the first identity information corresponds to the retrieved or stored identity number, modify the updated GUI to comprise an indication that the first identity information corresponds to the additional information.

Clause 6: The dynamic pre-approval system of clause 5, wherein the vehicle information comprises a vehicle price, vehicle identification number (VIN), vehicle make, vehicle model, vehicle year, or combinations thereof.

Clause 7: The dynamic pre-approval system of clause 1, wherein the memory stores further instructions that are configured to cause the system to: determine, using a machine learning model and a vehicle information database, whether the vehicle information is accurate; and responsive to determining that the vehicle information is not accurate, modify the updated GUI to comprise an indication that the vehicle information is not accurate.

Clause 8: The dynamic pre-approval system of clause 7, wherein the memory stores further instructions that are configured to cause the system to: responsive to determining that the vehicle information is accurate, modify the updated GUI to comprise an indication that the vehicle information is accurate.

Clause 9: The dynamic pre-approval system of clause 1, wherein generating the confidence score utilizes a machine learning model.

Clause 10: A dynamic pre-approval system comprising: one or more processors; memory in communication with the one or more processors and storing instructions that are configured to cause the dynamic pre-approval system to: receive first identity information; generate a pre-approval rate and a confidence score based on the first identity information; generate a graphical user interface (GUI) comprising the pre-approval rate, the confidence score, and a request for additional information; transmit the GUI to a user device for display; receive additional information; generate an updated pre-approval rate and an updated confidence score based on the first identity information and the additional information; generate an updated GUI comprising the updated pre-approval rate and the updated confidence score; and transmit the updated GUI to the user device for display in place of the GUI.

Clause 11: The dynamic pre-approval system of clause 10, wherein the first identity information comprises first name, last name, an identity number, birthdate, home address, or combinations thereof.

Clause 12: The dynamic pre-approval system of clause 11, wherein the additional information comprises a vehicle price, vehicle identification number (VIN), vehicle make, vehicle model, vehicle year, or combinations thereof.

Clause 13: The dynamic pre-approval system of clause 10 wherein: the first identity information comprises first name and last name; and the additional information comprises an identity number.

Clause 14: The dynamic pre-approval system of clause 13, wherein the memory stores further instructions that are configured to cause the system to: determine whether the first identity information corresponds to a retrieved or stored identity number; and responsive to determining that the first identity information does not correspond to the retrieved or stored identity number, modify the updated GUI to comprise an indication that the first identity information does not correspond to the additional information.

Clause 15: The dynamic pre-approval system of clause 14, wherein the memory stores further instructions that are configured to cause the system to: responsive to determining that the first identity information corresponds to the retrieved or stored identity number, modify the updated GUI to comprise an indication that the first identity information corresponds to the additional information.

Clause 16: The dynamic pre-approval system of clause 11, wherein the memory stores further instructions that are configured to cause the system to: determine, using a machine learning model and a vehicle information database, whether the vehicle information is accurate; and responsive to determining that the vehicle information is not accurate, modify the updated GUI to comprise an indication that the vehicle information is not accurate.

Clause 17: The dynamic pre-approval system of clause 16, wherein the memory stores further instructions that are configured to cause the system to: responsive to determining that the vehicle information is accurate, modify the updated GUI to comprise an indication that the vehicle information is accurate.

Clause 18: The dynamic pre-approval system of clause 10, wherein generating the confidence score utilizes a machine learning model.

Clause 19: A computer implemented method comprising: receiving first identity information; generating a pre-approval rate and a confidence score based on the first identity information; generating a graphical user interface (GUI) comprising the pre-approval rate, the confidence score, and a request for additional information; transmitting the GUI to a user device for display; receiving additional information; generating an updated pre-approval rate and an updated confidence score based on the first identity information and the additional information; generating an updated GUI comprising the updated pre-approval rate and the updated confidence score; and transmitting the updated GUI to the user device for display in place of the GUI.

Clause 20: The method of clause 19, wherein: the first identity information comprises first name, last name, an identity number, birthdate, home address, or combinations thereof; and the additional information comprises a vehicle price, vehicle identification number (VIN), vehicle make, vehicle model, vehicle year, or combinations thereof.

Clause 21: A dynamic pre-approval system comprising: one or more processors; memory in communication with the one or more processors and storing instructions that are configured to cause the dynamic pre-approval system to: cause a user device to display a graphical user interface (GUI) that includes a plurality of editable fields, a first subset of the plurality of editable fields associated with identity information, and a second subset of the plurality of editable fields associated with vehicle information; monitor the plurality of editable fields for edits; dynamically determine a pre-approval based on the monitoring of the plurality of editable fields by, for each edit of a plurality of edits to the plurality of fields: using a current state of the plurality of fields to generate a pre-approval rate and a confidence score; and causing the user device to update the GUI with the pre-approval rate and the confidence score based on the current state of the plurality of fields, such that the pre-approval rate and the confidence score are dynamically updated with each edit of the plurality of edits.

Clause 22: The dynamic pre-approval system of clause 11, wherein the identity information comprises first name, last name, an identity number, birthdate, home address, or combinations thereof.

Clause 23: The dynamic pre-approval system of clause 21 wherein: the first identity information comprises first name and last name.

Clause 24: The dynamic pre-approval system of clause 23, wherein determining the pre-approval further comprises: determining whether the identity information corresponds to a retrieved or stored identity number; and updating the GUI to comprise an indication that the identity information is not verified in response to determining that the identity information does not correspond to the retrieved or stored identity number.

Clause 25: The dynamic pre-approval system of clause 24, wherein determining the pre-approval further comprises updating the GUI to comprise an indication that the identity information corresponds is verified responsive to determining that the identity information corresponds to the retrieved or stored identity number.

Clause 26: The dynamic pre-approval system of clause 25, wherein the vehicle information comprises a vehicle price, vehicle identification number (VIN), vehicle make, vehicle model, vehicle year, or combinations thereof.

Clause 27: The dynamic pre-approval system of clause 21, determining the pre-approval further comprises determining, using a machine learning model and a vehicle information database, whether the vehicle information is accurate; and updating the GUI to comprise an indication that the vehicle information is not accurate in response to determining that the vehicle information is not accurate.

Clause 28: The dynamic pre-approval system of clause 27, determining the pre-approval further comprises updating the GUI to comprise an indication that the vehicle information is accurate responsive to determining that the vehicle information is accurate.

Clause 29: The dynamic pre-approval system of clause 21, wherein generating the confidence score utilizes a machine learning model trained to generate confidence scores from incomplete and complete identify information, vehicle information, or both.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A dynamic pre-approval system comprising:
one or more processors;
memory in communication with the one or more processors and storing instructions that are configured to cause the dynamic pre-approval system to:
cause a user device to display a graphical user interface (GUI) that includes a plurality of editable fields, a first subset of the plurality of editable fields associated with identity information, and a second subset of the plurality of editable fields associated with vehicle information;
monitor the plurality of editable fields for edits;
dynamically determine a pre-approval based on the monitoring of the plurality of editable fields by, for each edit of a plurality of edits to the plurality of fields:
using a current state of the plurality of fields to generate a pre-approval rate and a confidence score; and
causing the user device to update the GUI with the pre-approval rate and the confidence score based on the current state of the plurality of fields, such that the pre-approval rate and the confidence score are dynamically updated with each edit of the plurality of edits.

2. The dynamic pre-approval system of claim 1, wherein the identity information comprises first name, last name, an identity number, birthdate, home address, or combinations thereof.

3. The dynamic pre-approval system of claim 1 wherein:
the first identity information comprises first name and last name.

4. The dynamic pre-approval system of claim 3, wherein determining the pre-approval further comprises:
determining whether the identity information corresponds to a retrieved or stored identity number; and
updating the GUI to comprise an indication that the identity information is not verified in response to determining that the identity information does not correspond to the retrieved or stored identity number.

5. The dynamic pre-approval system of claim 4, wherein determining the pre-approval further comprises updating the GUI to comprise an indication that the identity information corresponds is verified in response to determining that the identity information corresponds to the retrieved or stored identity number.

6. The dynamic pre-approval system of claim 5, wherein the vehicle information comprises a vehicle price, vehicle identification number (VIN), vehicle make, vehicle model, vehicle year, or combinations thereof.

7. The dynamic pre-approval system of claim 1, wherein determining the pre-approval further comprises:
determining, using a machine learning model and a vehicle information database, whether the vehicle information is accurate; and
updating the GUI to comprise an indication that the vehicle information is not accurate in response to determining that the vehicle information is not accurate.

8. The dynamic pre-approval system of claim 7, wherein determining the pre-approval further comprises updating the GUI to comprise an indication that the vehicle information is accurate in response to determining that the vehicle information is accurate.

9. The dynamic pre-approval system of claim 1, wherein generating the confidence score utilizes a machine learning model trained to generate confidence scores from incomplete and complete identify information, vehicle information, or both.

10. A dynamic pre-approval system comprising:
one or more processors;
memory in communication with the one or more processors and storing instructions that are configured to cause the dynamic pre-approval system to:
receive first identity information;
generate a pre-approval rate and a confidence score based on the first identity information;
generate a graphical user interface (GUI) comprising the pre-approval rate, the confidence score, and a request for additional information;
transmit the GUI to a user device for display;
receive additional information;
generate an updated pre-approval rate and an updated confidence score based on the first identity information and the additional information;
generate an updated GUI comprising the updated pre-approval rate and the updated confidence score; and
transmit the updated GUI to the user device for display in place of the GUI.

11. The dynamic pre-approval system of claim 10, wherein the first identity information comprises first name, last name, an identity number, birthdate, home address, or combinations thereof.

12. The dynamic pre-approval system of claim 11, wherein the additional information comprises a vehicle price, vehicle identification number (VIN), vehicle make, vehicle model, vehicle year, or combinations thereof.

13. The dynamic pre-approval system of claim 10 wherein:
the first identity information comprises first name and last name; and
the additional information comprises an identity number.

14. The dynamic pre-approval system of claim 13, wherein the memory stores further instructions that are configured to cause the system to:
determine whether the first identity information corresponds to a retrieved or stored identity number; and
responsive to determining that the first identity information does not correspond to the retrieved or stored identity number, modify the updated GUI to comprise an indication that the first identity information does not correspond to the additional information.

15. The dynamic pre-approval system of claim 14, wherein the memory stores further instructions that are configured to cause the system to:
responsive to determining that the first identity information corresponds to the retrieved or stored identity number,
modify the updated GUI to comprise an indication that the first identity information corresponds to the additional information.

16. The dynamic pre-approval system of claim 11, wherein the memory stores further instructions that are configured to cause the system to:
determine, using a machine learning model and a vehicle information database, whether the vehicle information is accurate; and
responsive to determining that the vehicle information is not accurate, modify the updated GUI to comprise an indication that the vehicle information is not accurate.

17. The dynamic pre-approval system of claim 16, wherein the memory stores further instructions that are configured to cause the system to:
responsive to determining that the vehicle information is accurate, modify the updated GUI to comprise an indication that the vehicle information is accurate.

18. The dynamic pre-approval system of claim 10, wherein generating the confidence score utilizes a machine learning model.

19. A computer implemented method comprising:
receiving first identity information;
generating a pre-approval rate and a confidence score based on the first identity information
generating a graphical user interface (GUI) comprising the pre-approval rate, the confidence score, and a request for additional information;
transmitting the GUI to a user device for display;
receiving additional information;
generating an updated pre-approval rate and an updated confidence score based on the first identity information and the additional information;
generating an updated GUI comprising the updated pre-approval rate and the updated confidence score; and
transmitting the updated GUI to the user device for display in place of the GUI.

20. The method of claim 19, wherein:
the first identity information comprises first name, last name, an identity number, birthdate, home address, or combinations thereof; and
the additional information comprises a vehicle price, vehicle identification number (VIN), vehicle make, vehicle model, vehicle year, or combinations thereof.
